(19) United States
(12) Patent Application Publication
(10) Pub. No.: US 2023/0100501 A1
(43) Pub. Date: Mar. 30, 2023

(54) DYNAMICALLY GENERATED KNOWLEDGE GRAPHS

(71) Applicant: INTERNATIONAL BUSINESS MACHINES CORPORATION, ARMONK, NY (US)

(72) Inventors: Chao Yu, Ningbo (CN); Yan Bin Fu, Ningbo (CN); Yi Wu, Ningbo (CN); Qing Jun Gao, Beijing (CN); Qing Xia, Xian (CN)

(21) Appl. No.: 17/449,116

(22) Filed: Sep. 28, 2021

(51) Int. Cl. G06N 5/02; G06F 16/906; G06F 16/9536; H04L 29/08

(52) U.S. Cl. CPC G06N 5/022; G06F 16/906; G06F 16/9536; H04L 67/22

(57) ABSTRACT

A computer system, method, and computer program product comprise clustering data of search results of a topic of interest into a hierarchical knowledge tree format, monitoring computer user behavior regarding the search results, and processing a determined result of the monitored computer user behavior and the clustered data of the search results to generate a knowledge graph based on the topic of interest.

### BACKGROUND

The present invention relates generally to online collaboration, and in particular to a system and method that generate graphical hierarchical knowledge trees constructed according to group browsing behavior.

With the continuing rapid advancement of information technology and the storage of data in the form of electronic documents by organizations such as universities and enterprises. Electronic documents may include emails, multimedia, articles, interne webpages, social media, document files, and so on that are stored at an information repository such as a knowledge base, where the data can be shared, searched, and retrieved by users. When a group, team, or the like collaborate on a project, or more specifically, a particular topic at a particular stage, the group members may perform research involving electronic data searching. The search results are important and efficient for the knowledge base of the team and the enterprise.

However, after a first group completes the topic processing at a particular stage of a project, the search results are often not preserved, which can result in duplicate efforts with respect to a second group unaware of the first group's efforts regarding the project. Moreover, different groups such as project teams may produce different knowledge structures, which can result in a disorderly knowledge system and inaccurate output solutions. A final product is produced according to different approaches and varying and inconsistent complexities. For example, team members may perform research on an open source application to be installed. However, the manner in which the application is installed may vary in an undesirable manner due to the various search results retrieved regarding the application.

Accordingly, as more enterprise solutions are developed as e-documents, when a team is at a particular stage of topic processing involving substantial research in a short period of time, it is desirable that this specific stage of knowledge for a team be carried out with a comprehensive, organized, and efficient enterprise knowledge base.

### SUMMARY

A first aspect of the invention provides a computer system comprising: one or more processors; one or more memory devices coupled to the one or more processors; and one or more computer readable storage devices coupled to the one or more processors, the one or more computer readable storage media collectively containing instructions that are executed by the one or more processors via the one or more memory devices to cause the one or more processors to implement a knowledge graph formation method, comprising: clustering, by the CPU, data of search results of a topic of interest into a hierarchical knowledge tree format; monitoring by the CPU, computer user behavior regarding the search results; and processing by the CPU, a determined result of the monitored computer user behavior and the clustered data of the search results to generate a knowledge graph based on the topic of interest.

A computer program product and a method corresponding to the above-summarized computer system are also described and claimed herein.

### BRIEF DESCRIPTION OF THE DRAWINGS

FIG. 1 depicts an example computer architecture at which embodiments of the present invention may be implemented.

FIG. 2 is a block diagram of a knowledge graph system, in accordance with embodiments of the present invention.

FIG. 3 is a flow diagram that depicts a method for constructing a knowledge graph based on group browsing behavior, in accordance with embodiments of the present invention.

FIG. 4 depicts an example of the formation of a knowledge graph from the iterative addition of search criteria, in accordance with embodiments of the present invention.

FIG. 5 depicts an example of an operation of iteratively updating a knowledge graph, in accordance with embodiments of the present invention.

FIG. 6 illustrates a knowledge graph, in accordance with embodiments of the present invention.

FIG. 7 illustrates a computer system used by the knowledge graph system of FIGS. 1 and 2 and that implements the method of FIG. 3 and examples of FIGS. 4-6, in accordance with embodiments of the present invention.

FIG. 8 illustrates a cloud computing environment, in accordance with embodiments of the present invention.

FIG. 9 illustrates a set of functional abstraction layers provided by cloud computing environment, in accordance with embodiments of the present invention.

### DETAILED DESCRIPTION

In brief overview, embodiments of the present disclosure relate to a system and method that help enterprises establish an orderly and efficient knowledge system by generating knowledge graphs based on a user's interactions such as computer browsing behavior, especially in a team setting where team members collaborate electronically. The knowledge graphs allow for structured knowledge extracted from texts, databases or other sources, making it available for queries by the team members. The knowledge system allows users to search for a topic for problem-solving purposes by determining the corresponding solution on the knowledge graph of other users. This feature avoids the need to search for the solution at a data source comprising substantial quantities of data. In particular, the user's browsing behavior improves the search accuracy of a topic and avoids the need for repeated searches involving substantial exchanges of large quantities of data. For example, the research and development (R&D) team of a company can search for a particular topic problem to find a corresponding solution based on the optimized knowledge graph of other employees or teams, instead of duplicating the effort of searching for a solution to the problem.

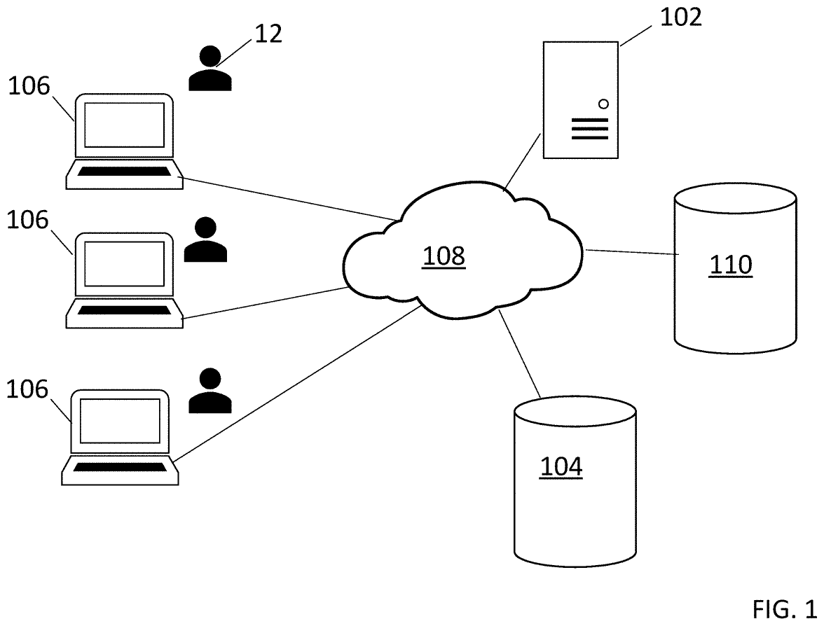

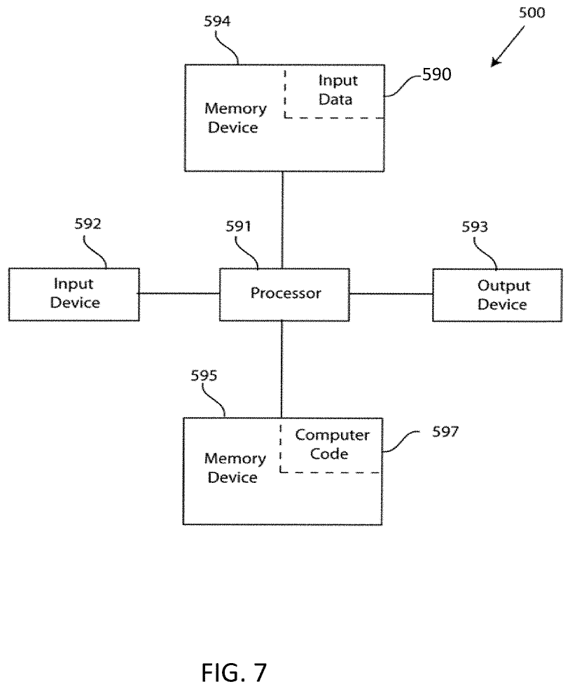

FIG. 1 depicts an example computer architecture at which embodiments of the present invention may be implemented. In FIG. 1, a plurality of user computers 106 are electronically coupled to a knowledge graph generator platform 102 and an information repository 104. The knowledge graph generator platform 102 and information repository 104 can each comprise specialized hardware comprising circuitry, for example, shown in FIG. 7, for storing and/or executing the process described herein.

One or more user computers 106 may be a desktop computer, a laptop computer, a smartphone, a tablet computer, and/or any other networked computer communicating with the knowledge graph generator platform 102, an information repository 104, and web data source 110 via a network 108. Each user computer 106 may comprise a user interface through which a user may enter commands and/or other interact with data and receive graphical data or the like. The displayed graphical representation may be transformed into the search query in client computer 100 and/or the search computer 102.

The knowledge graph generator platform 102 may comprise one or more server computers or other hardware processor based apparatuses. The knowledge graph generator platform 102 may comprise a networked computer, for example, shown and described with reference to FIGS. 7-9, that acts as a server communicating via the network 108 to one or more user computers 106.

The knowledge graph generator platform 102 is constructed and arranged to generate knowledge graphs based on a combination of inputs, including but not limited to one or more of keyword-based research topics, domain users, user browsing behaviors, and user interactions, which allows group users to analyze knowledge and share the knowledge with others. For example, domain users may pertain to a network domain where users in the same local area network collaborate on the same topics. The domain limitation can assist with reduce topics, behaviors, and interactions, etc. that the knowledge graph can be generated at a topic scope that is manageable. Such inputs may be received from structured or semi-structured data on search engines, mail groups, communities, chatbots, hotlines, and so on, but not limited thereto. The knowledge graph generator platform 102 includes an input for refining the knowledge system. The knowledge graph generator platform 102 can also generate a knowledge graph version library. For example, a version library can be provided to allow the knowledge graph to manage different answers or solutions for a topic or subtopic. An initial version can be added with a topic or subtopic of interest. Answers or solutions refining to a topic or subtopic are added as a new version.

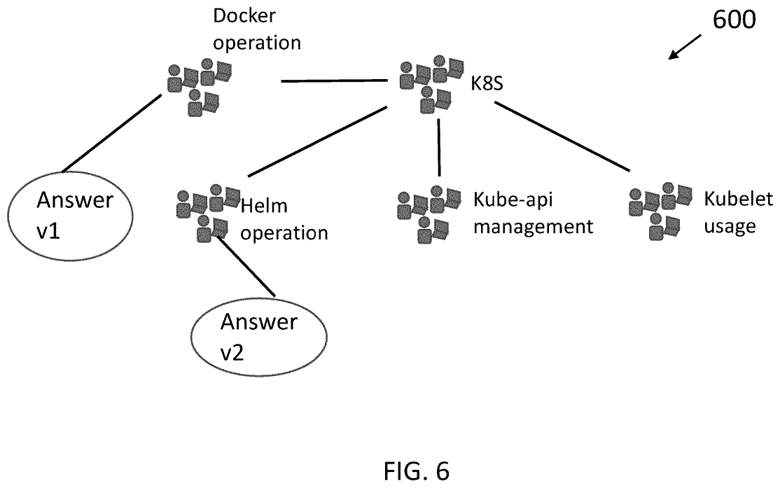

In some embodiments, a user can enter content corresponding to a generated knowledge graph to form a new or modified knowledge graph, for example, a new version, that includes a level of accuracy acceptable to the user. The knowledge graph generator platform 102 can also generate dynamic leaf nodes in the hierarchy based on subtopics. Since a knowledge graph is a hierarchy tree, it will automatically generate a new leaf node if the topic or subtopic does not exist in the knowledge graph. In this example, there is a topic “Application” in the knowledge graph, and subtopics “Application Installation”, “Application Deployment”, etc. are generated as new leaf nodes. Another example is illustrated in FIG. 6. The knowledge graph generator platform 102 can reprocess knowledge data to refine the knowledge system. For example, a user may review a knowledge graph, and wish to edit the knowledge based on the current knowledge graph. In doing so, the knowledge graph generator platform 102 can compare the currently edited knowledge with the contents of the knowledge graph and form a new knowledge graph that includes combinations of data of the original knowledge graph and the edited knowledge data.

The information repository 104 can include a knowledge base, graph database, or the like. The knowledge base can store complex structured and unstructured information. The knowledge base can include a document library or the like for the collection of digitally stored content in system readable form, and provided from various sources that can be output as answers to user queries. Electronic documents may include emails, multimedia, articles, internet webpages, social media, document files, and so on that are stored at the information repository 104.

The data source platform 110 may provide data to the knowledge graph generator platform 102, information repository 104, and/or computers 106 such as search results of a topic of interest from various entities and relationships, such as search engines, mail groups, communities, chatbots, hotlines, and so on.

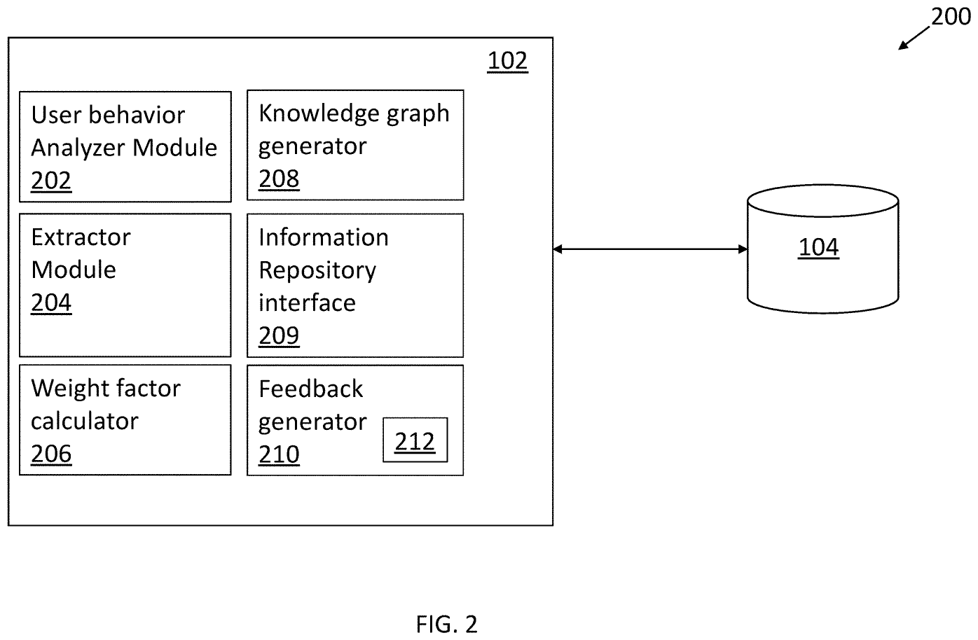

FIG. 2 is a block diagram of a knowledge graph system 200, in accordance with embodiments of the present invention. In particular, shown and described are primary components of the knowledge graph generator platform 102 and information repository 104 forming the knowledge graph system 200. Some or all of the knowledge graph system 200 can be implemented in the computer system 500 of FIG. 7. One or more of the modules of the knowledge graph system 200 comprises specialized hardware and software for controlling all functions related to the steps of the algorithms described in embodiments herein.

In some embodiments, the knowledge graph generator platform 102 comprises a user behavior analyzer module 202, an extractor module 204, a weight factor calculator 206, a knowledge graph generator 208, an information repository interface 209, a feedback generator 210, and a rules engine 212.

The user behavior analyzer module 202 receives and processes data regarding user online activities such as browsing behavior during use of the user computers 106. User browsing behaviors can impact the processing of building a knowledge graph about a topic. A knowledge graph about a particular topic can be automatically generated based on a group member's browsing behavior. For example, browser search patterns may be extracted from a user's behavior and analyzed, for example, mouse swipe motions, copy/paste, time duration of a particular search, and so on.

The extractor module 204 extracts search results of a topic or subtopic of interest from various entities and relationships, such as search engines, mail groups, communities, chatbots, hotlines, and so on. The extractor module 204 can receive such data from the data source platform 110, or other third-party data source. For example, the extractor module 204 can extract information from data sources at a target domain. Extracted information may include keywords and semantic relationships. In some embodiments, the rules engine 212 can apply a learning algorithm or the like to generate one or rules for extracting the information from the search results. A user input such as keywords are input to the computer to permit the user to search for a solution to a topic-related question, for example, a computer executing an NLP algorithm is used to extract the meaningful words from a search query. In some embodiments, a semantic language model can be constructed for a knowledge graph pertaining to a search for data involving semantic relationships.

As described herein, the knowledge graph system 200 clusters the search results of an identified topic via a clustering algorithm into a hierarchical knowledge tree. The user behavior analyzer module 202 can analyze the team members' interaction behavior regarding computer activity such as mouse swipes, copies, page stay time, etc., with the search result which belongs to one or some data clusters or classifications after which the system extracts the entities and relationships of the search result. The weight factor calculator 206 can increase or decrease the weight of these generated clusters and communicate with the knowledge graph generator 208 to form a special knowledge graph with an individual topic tree and related sub result which is confirmed by the weight factor. For example, if the behavior analyzer module 202 establishes that a user performs a repeated mouse motion for copying particular information pertaining to a specified topic, then the weight factor calculator 206 can apply a factor that increases the weight of the current knowledge graph. As described herein, clusters are generated followed by a change in weight of clusters to form a special knowledge graph with an individual topic tree and related sub-result confirmed by the weight factor, e.g., weights assigned to the edges and nodes in the representation. A sub-result is related to a subtopic that relates to a topic. Two different sub-results can have different weights.

The knowledge graph generator 208 can generate knowledge graphics based on a combination of topics and domain users, user browsing behavior, and user interactions. In some embodiments, the knowledge graph generator 208 generates a knowledge graph version library and dynamic leaf nodes based on subtopics. For example, a topic entitled “Kubernetes” may have related subtopics “Kubernetes deployment,” “Kubernetes management”, etc. In some embodiments, the knowledge graph generator 208 generates a tree-shaped knowledge graph, i.e., displaying interconnected entities, based on topic.

The information repository interface 209 forms a communication path either directly or indirectly via a computer network of the like with one or more information repositories such as information repository 104 (but not limited thereto) that allow the user computers 106 to collect search results and for the system 102 to process search query data. For example, users from a professional group or organization such as a research and development (R&D) may desire to find a solution of an individual topic (key words) via structured or semi-structured data on search engines, mail groups, communities, chatbots, hotlines and so on. In some embodiments, the information repository interface 209 translates non-graphical data received from the knowledge base 104 and/or third-party data source into a format that can be processed by the knowledge graph generator 208.

The feedback generator 210 permits the knowledge graph generator 208 to generate new or updated knowledge graphs when the system receives data indicating that a user or group of users is not satisfied with the current search results, where a search condition or first criteria can be added to obtain a deeper search result. In response to a receipt of feedback data from the feedback generator 210, the knowledge graph generator 208 can generate a revised hierarchical tree structure, including subtrees of children nodes closest to the root node. The feedback generator 210 can provide additional search conditions from the user to the knowledge graph generator 208 when the user is not satisfied with initial search results or updated search results to generate a deeper knowledge graph.

The rules engine 212 processes one or more rules applied to received search results. For example, a search result may be selected to optimize a knowledge graph. The feedback generator may discard unnecessary or irrelevant search result content for compliance to the rules executed by the rules engine 212. The rules may be stored in memory of the knowledge graph generator platform 102, or stored at the knowledge base 104 and retrieved by the rules engine 212 for processing. The rules can establish conditions under which user activities regarding the user computer 14 are monitored, and under which weight scores are provided. Additional details are described with reference to FIG. 7. For example, the rules engine can store a rules, condition, or association to determine a user highlighting particular sections of a retrieved journal article for over 30 sections as indicative of a high confidence level that the user is satisfied with the retrieved journal article, and in doing so, a weight factor corresponding to the knowledge graph is updated based on this behavior.

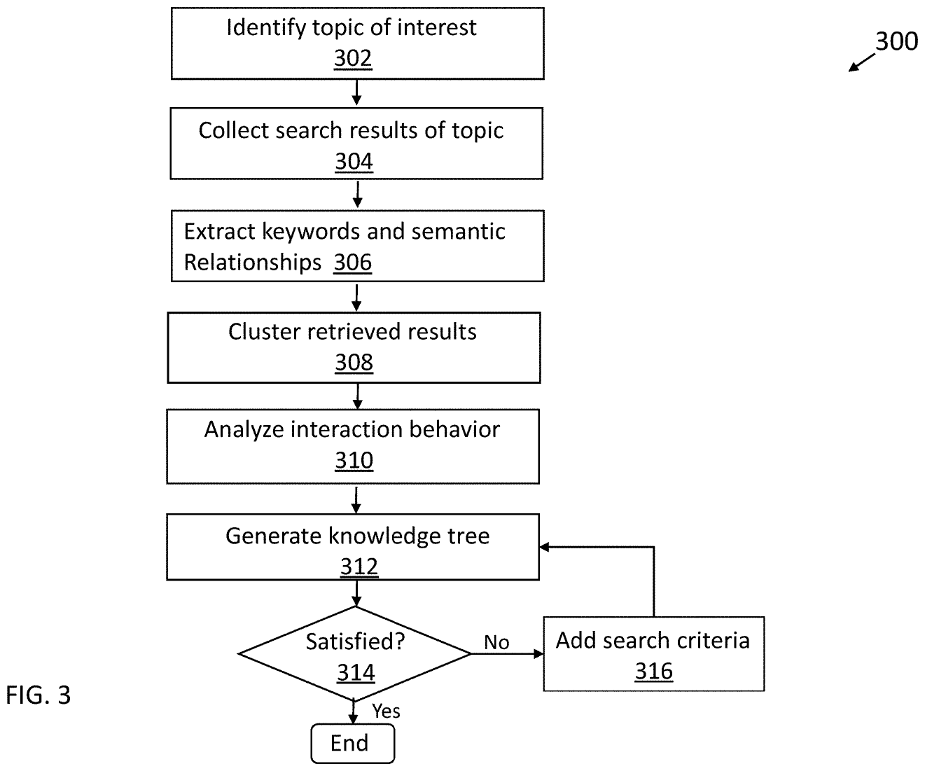

FIG. 3 is a flow diagram that depicts a method 300 for constructing a knowledge graph based on group browsing behavior, in accordance with embodiments of the present invention. Some or all of the method 300 can be performed by the knowledge graph generator platform 102 of FIGS. 1 and 2, but not limited thereto. Each of the steps in the method 300 may be enabled and executed in any order by a hardware processor executing computer code, for example, shown and described with reference to FIGS. 7-9. Additionally, each method step may be enabled and executed in combination by a computer memory device, for example, and described with reference to FIGS. 7-9.

At block 302, a topic of interest is identified. A team of individuals may collaborate on a project, and in doing so attempt to address a particular topic at a certain stage, which may require search efforts.

At block 304, a search query related to the topic of interest across on or more heterogeneous data sources. The search results are collected by one or more members of the team and stored at the information repository 104. The search results may be received from internal data sources, for example, at the information repository 104 and/or from external data sources such as search engines, social media communities, and so on, but not limited thereto.

At block 306, the search results of the topic data are processed by the knowledge graph generator platform 102 for preparation of a knowledge graph with the search context. This may include extracting keywords and semantic relationships derived from the search results after clustering. The knowledge graph generator platform 102 can extract keywords and semantic relationships, for example, where the keyword is the user input to search for a solution, and where an NLP algorithm is executed to extract the meaningful words from a search query.

At block 308, the extractor module 204 may execute a knowledge-based clustering technique that is applied to the information repository to cluster input objects of the search result data processed in block 306. For example, entity data such as nouns and verbs are extracted from the text. In some embodiments, the entity data is parsed, and meaningful relationships between the entities are identified. In some embodiments, a clustering algorithm is applied for executing Connectivity-based clustering technique to the search result data for forming a knowledge tree or the like.

At block 310, the user behavior analyzer module 202 can analyze the team members' interaction behavior such as mouse swipes, data copying, page stay time, etc. along with the search results associated with the generated clusters to extract the entities and relationships of the search result.

At block 312, a knowledge tree is generated from the data clusters generated at block 308. The knowledge tree may include an array of nodes corresponding to the entity data described in block 308. In some embodiments, the knowledge tree includes labels for the extracted relations and relationship connectors or links that illustrate how the entity data are connected, and wherein the nodes are the entities and edges are the relationships between them.

At decision diamond 314, a determination is made whether the generated knowledge tree is acceptable to the users. If no, then the method 300 proceeds to block 316 where at least one user adds one or more new search conditions, then returns to block 312 where a new and deeper knowledge graph is generated.

In the above steps, the method 300 can combine the user's profile, for example, including subject matter expertise information, and update the weight of the knowledge graph of the current node by detecting and analyzing behaviors regarding a user 12 and the user's computer 106, such as a detection of the user performing a data copy/paste function, highlighting, bookmarking, or forwarding articles, or portions such as paragraphs thereof, displayed on the computer 106, and so on. By analyzing user behavior with respect to search results that correspond to particular generated data clusters, the entities and relationships of the search results can be extracted and processed.

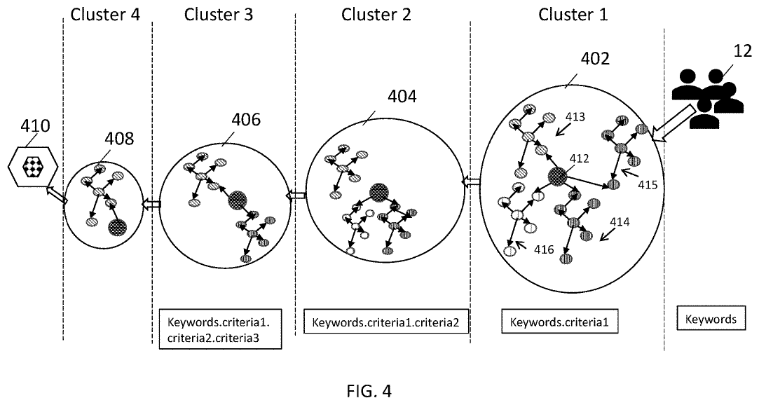

FIG. 4 depicts an example of the formation of a knowledge graph from the iterative addition of search criteria, in accordance with embodiments of the present invention.

As described above, a group of users 12 may work together to identify a solution to a problem. A search for a solution to the problem produces results comprising keywords, which are extracted and clustered to generate a first knowledge graph tree 402 formed of a root node 412 and a plurality of child nodes constructed and arranged in clusters 413, 414, 415, 416.

When a certain group of users is not satisfied with the current search results, a user can add a search condition (Criteria 1) to obtain a deeper search result. If a user continues to be dissatisfied with the accuracy of the search results, the user can add more search conditions to generate a deeper knowledge graph 404, 406, 408, etc. Accordingly, an accurate knowledge map of the top is generated when a group of topic stakeholders have similar behaviors and feedback regarding the current knowledge map (which can be modified by users) to recommended answers of the map has a high confidence level established by one or more factors including the understanding that shorter standard answers are more accurate than longer answers, a highest possibly combination of plain text and code, and an understanding that the greater the difference between the current knowledge graph and the original knowledge graph, the more accurate the contents of the current knowledge graph.

Once a search result is generated by one team, there is no need for members of another team, or other members of the same team, to perform a similar search query. Therefore, there is no need to process multiple results corresponding to a common search query. Instead, if a second team is not satisfied with a search result of a first team, and wishes to perform a new search query, then the result of the new search query is fed back to the initial knowledge graph to form a new version of the knowledge graph so that no conflict arises with the previous version.

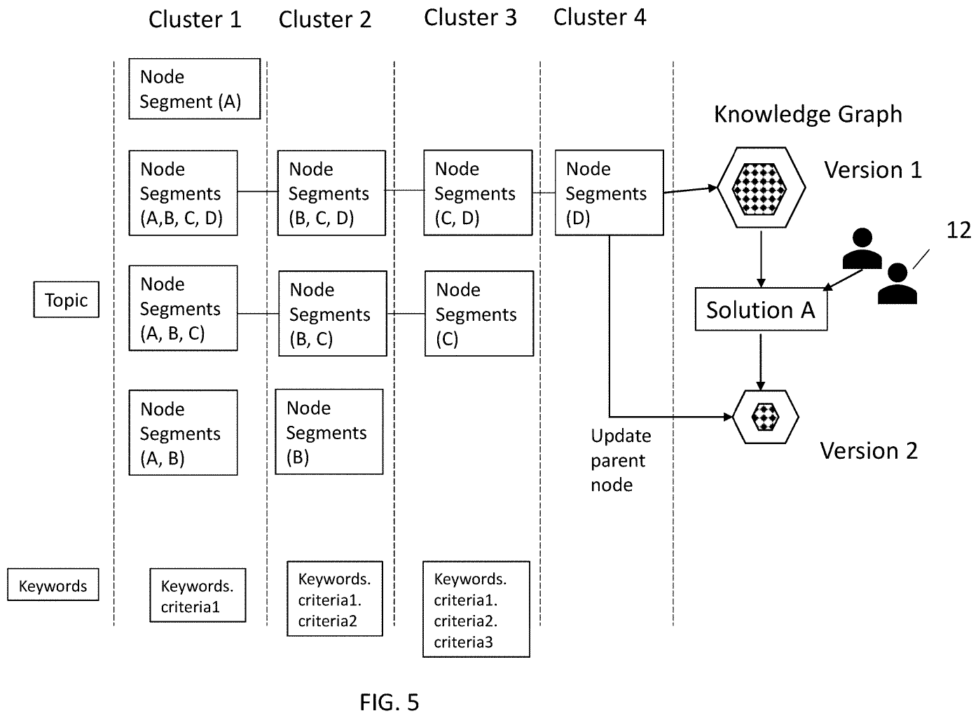

As shown and described in FIG. 5, dissatisfied knowledge graph users can edit a current knowledge graph to improve its accuracy by adding criteria. Here, various users may add criteria, similar to FIG. 4. In doing so, cluster combinations are formed, namely, including node segments (A, B, C, D), which may be similar to the clusters shown in FIG. 4. Cluster 4 is formed in response to the addition of three additional criteria. The editing result, e.g., Version 2 shown in FIG. 5, can be fed to the current knowledge graph, namely, Cluster 4, to optimize a recommendation result, or Solution A. The clustering process illustrated from Cluster 1 to Cluster 4 allows for increasing accuracy with respect to processing search results and their corresponding topics. Node segments A-D illustrate that there may be various results generated from a search query, and that the more criteria that is applied, the more accurate the result, e.g., Solution A.

In some embodiments, a complete and optimized knowledge graph with search context can be generated by an individual project group searching for a topic of interest. Details on the topic searched by the individual project group can be recorded and abstracted, fusioned, and processed to connect the team members to incorporate the knowledge graph. Based on a search result selected to optimize the knowledge graph irrelevant information in the search result is discarded so that the rules engine 212 can be activated to process the relevant information according to the predetermined rule set. Here, user activities are monitored and answers on which particular activities are detected require a higher weight when generating weight scores. Example activities may include copy/paste operations performed by the user or a determination of a browse or stay time exceeding a predetermined threshold. For each specific topic, answers with higher scores are adopted and processed. Crossed answers with lower scores for a first topic but a higher score for a second topic is adopted by the second topic. Answers with a lower score for any topic is treated as irrelevant and discarded.

For example, as shown in FIG. 6 a knowledge graph 600 can correspond to a Kubernetes cluster, which includes of a set of user machines, or nodes, that run containerized applications. The knowledge graph 600 includes an individual topic tree and a related subtree of at least one child node closest to a root node of the individual topic tree. For example, root node (K8S) has two subtrees to which a Docker operation node and Helm operation node perform a search. The Helm operation inquiry may produce a low score while the Docker operation inquiry produces a high score. Accordingly, Answer v1 having a lower score is crossed off the topic of the Helm operation but the higher score for the topic of the Docker operation may be adopted by the higher score topic.

In some embodiments, a knowledge graph can be generated by the system that is refined with reprocessed documents. For example, the system can provide answers to user inquiries as a draft solution to a specific topic. After the user reprocesses it, for example, adding or modify data regarding the initial inquiry and answer, the reprocessed information can be input to the system for generating a refined knowledge graph or the like. In some embodiments, the knowledge system generates an answer based on version or usage. For example, an answer having a latest version as compared to other answers with varying version is returned to the knowledge graph tree. In another example, an answer having a maximum usage may return a different answer, for example, an answer having an earlier version than the latest version.

In some embodiments, the knowledge system processes knowledge information based on a set of predetermined rules, which can be stored and processed at the abovementioned rules engine. For example, a rule may establish that usage is added for an answer that is matched more than 80% by the input, or else add a new version for the topic.

FIG. 7 illustrates a computer system 500 used by or comprised by the system, method, and examples of FIGS. 1-6 for improving software and memory system technology associated with utilizing hardware and software resources within a hybrid cloud environment and enabling a non-volatile memory host system and an associated target system for operational functionality; connecting the non-volatile memory host system to an I/O queueing component and generating queue structures with respect to a host driver component; and enabling the queue structures and a generated special purpose cache structure such that remote data mirroring functionality is enabled, in accordance with embodiments of the present invention.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, spark, R language, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, device (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer system 500 illustrated in FIG. 7 includes a processor 591, an input device 592 coupled to the processor 591, an output device 593 coupled to the processor 591, and memory devices 594 and 595 each coupled to the processor 591. The input device 592 may be, inter alia, a keyboard, a mouse, a camera, a touchscreen, etc. The output device 593 may be, inter alia, a printer, a plotter, a computer screen, a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 595 includes a computer code 597. The computer code 597 includes algorithms (e.g., the algorithms of FIGS. 1 and 3-5) for improving software and memory system technology associated with utilizing hardware and software resources within a hybrid cloud environment and enabling a non-volatile memory host system and an associated target system for operational functionality; connecting the non-volatile memory host system to an I/O queueing component and generating queue structures with respect to a host driver component; and enabling the queue structures and a generated special purpose cache structure such that remote data mirroring functionality is enabled. The processor 591 executes the computer code 597. The memory device 594 includes input data 596. The input data 596 includes input required by the computer code 597. The output device 593 displays output from the computer code 597. Either or both memory devices 594 and 595 (or one or more additional memory devices such as read only memory device 596) may include algorithms and may be used as a computer usable medium (or a computer readable medium or a program storage device) having a computer readable program code embodied therein and/or having other data stored therein, wherein the computer readable program code includes the computer code 597. Generally, a computer program product (or, alternatively, an article of manufacture) of the computer system 590 may include the computer usable medium (or the program storage device).

In some embodiments, rather than being stored and accessed from a hard drive, optical disc or other writeable, rewriteable, or removable hardware memory device 595, stored computer program code 597 (e.g., including algorithms) may be stored on a static, nonremovable, read-only storage medium such as a Read-Only Memory (ROM) device, or may be accessed by processor 591 directly from such a static, nonremovable, read-only medium. Similarly, in some embodiments, stored computer program code 597 may be stored as computer-readable firmware, or may be accessed by processor 591 directly from such firmware, rather than from a more dynamic or removable hardware data-storage device 595, such as a hard drive or optical disc.

Still yet, any of the components of the present invention could be created, integrated, hosted, maintained, deployed, managed, serviced, etc. by a service supplier who offers to improve software and memory system technology associated with utilizing hardware and software resources within a hybrid cloud environment and enabling a non-volatile memory host system and an associated target system for operational functionality; connecting the non-volatile memory host system to an I/O queueing component and generating queue structures with respect to a host driver component; and enabling the queue structures and a generated special purpose cache structure such that remote data mirroring functionality is enabled. Thus, the present invention discloses a process for deploying, creating, integrating, hosting, maintaining, and/or integrating computing infrastructure, including integrating computer-readable code into the computer system 500, wherein the code in combination with the computer system 500 is capable of performing a method for enabling a process for improving software and memory system technology associated with utilizing hardware and software resources within a hybrid cloud environment and enabling a non-volatile memory host system and an associated target system for operational functionality; connecting the non-volatile memory host system to an I/O queueing component and generating queue structures with respect to a host driver component; and enabling the queue structures and a generated special purpose cache structure such that remote data mirroring functionality is enabled. In another embodiment, the invention provides a business method that performs the process steps of the invention on a subscription, advertising, and/or fee basis. That is, a service supplier, such as a Solution Integrator, could offer to enable a process for improving software and memory system technology associated with utilizing hardware and software resources within a hybrid cloud environment and enabling a non-volatile memory host system and an associated target system for operational functionality; connecting the non-volatile memory host system to an I/O queueing component and generating queue structures with respect to a host driver component; and enabling the queue structures and a generated special purpose cache structure such that remote data mirroring functionality is enabled. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 7 shows the computer system 500 as a particular configuration of hardware and software, any configuration of hardware and software, as would be known to a person of ordinary skill in the art, may be utilized for the purposes stated supra in conjunction with the particular computer system 500 of FIG. 7. For example, the memory devices 594 and 595 may be portions of a single memory device rather than separate memory devices.

### Cloud Computing Environment

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

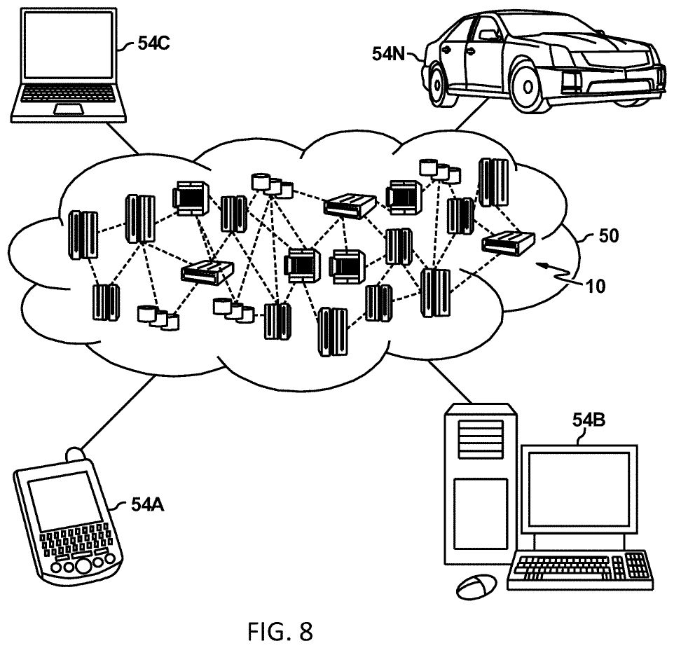

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 8 are intended to be illustrative only and that computing nodes 10 and cloud computing environment 50 can communicate with any type of computerized device over any type of network and/or network addressable connection (e.g., using a web browser).

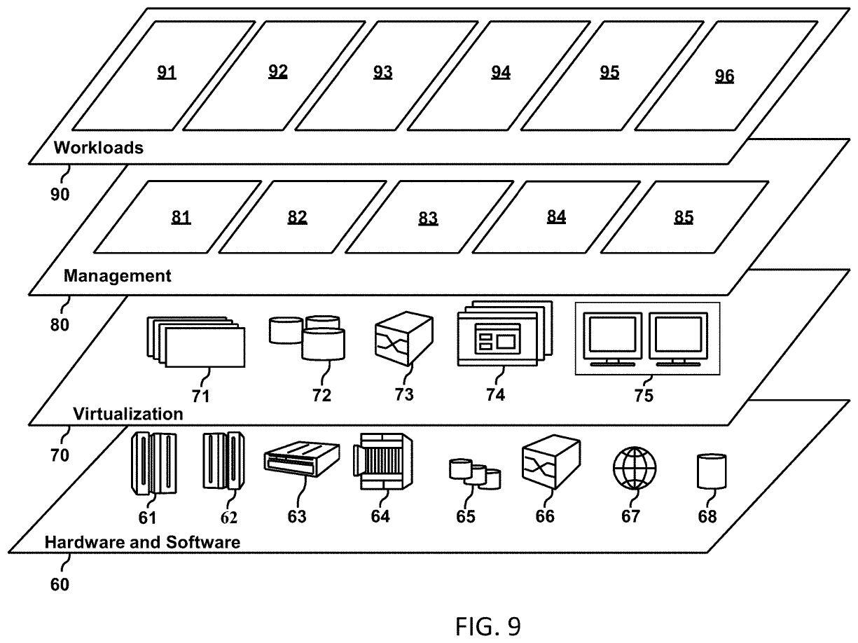

Referring now to FIG. 9, a set of functional abstraction layers provided by cloud computing environment 50 is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 87 provides cloud computing resource allocation and management such that required service levels are met. Service Level Agreement (SLA) planning and fulfillment 88 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and for improving software and memory system technology associated with utilizing hardware and software resources within a hybrid cloud environment and enabling a non-volatile memory host system and an associated target system for operational functionality; connecting the non-volatile memory host system to an I/O queueing component and generating queue structures with respect to a host driver component; and enabling the queue structures and a generated special purpose cache structure such that remote data mirroring functionality is enabled 96.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A computer system comprising:
one or more processors;
one or more memory devices coupled to the one or more processors; and
one or more computer readable storage devices coupled to the one or more processors, the one or more computer readable storage media collectively containing instructions that are executed by the one or more processors via the one or more memory devices to cause the one or more processors to implement a knowledge graph formation method, comprising:
clustering, by the one or more processors, data of search results of a topic of interest into a hierarchical knowledge tree format;
monitoring by the one or more processors, computer user behavior regarding the search results; and
processing by the one or more processors, a determined result of the monitored computer user behavior and the clustered data of the search results to generate a knowledge graph based on the topic of interest.

2. The computer system of claim 1, the method further comprising:
calculating, by the one or more processors, a weight factor from the monitored computer user behavior; and
applying by the one or more processors, the weight factor to the clustered data to generate the knowledge graph.

3. The computer system of claim 2, wherein the generated knowledge graph includes an individual topic tree and a related subtree of at least one children node closest to a root node of the individual topic tree.

4. The computer system of claim 1, wherein the customer user behavior includes at least one of a computer mouse motion, a copy and paste operation, highlighting text of an article of the search results, bookmarking an article of the search results, or forwarding an article of the search results.

5. The computer system of claim 1, the method further comprising:
in response to analyzing the computer user behavior regarding the search results, extracting, by the one or more processors, the search results from entities and relationships and combining interactive behavior permissions established by recording the topic of interest and search results clustered into the hierarchical knowledge tree format to form the knowledge graph of the specific topic tree and a result from sub-topics branched from the knowledge tree.

6. The computer system of claim 1, the method further comprising:
generating, by the one or more processors, a new version of the knowledge graph by outputting additional information from reprocessed documents of the search results.

7. The computer system of claim 6, the method further comprising:
adding or modifying, by the one or more processors, data regarding an initial inquiry;
inputting information corresponding to the reprocessed documents to the computer system for generating the new version of the knowledge graph;
generating, by the one or more processors, an answer based on either the version of the knowledge graph or amount of use of the answer.

8. The computer system of claim 6, wherein the new version of the knowledge graph is generated in response to user-entered information as part of adding or modifying, by the one or more processors, data regarding an initial inquiry.

9. The computer system of claim 6, the method further comprising:
receiving, by the one or more processors, an additional search condition or criteria;
generating, by the one or more processors, a new or modified knowledge graph.

10. A knowledge graph formation method, comprising:
clustering, by one or more processors of a computer system, data of search results of a topic of interest into a hierarchical format;
monitoring, by the by one or more processors of the computer system, computer user behavior regarding the search results; and
processing, by the by one or more processors of the computer system, a determined result of the monitored computer user behavior and the clustered data of the search results to generate a knowledge graph based on the topic of interest.

11. The knowledge graph formation method of claim 10, further comprising:
calculating, by the by one or more processors of the computer system, a weight factor from the monitored computer user behavior; and
applying, by the by one or more processors of the computer system, the weight factor to the clustered data to generate the knowledge graph.

12. The knowledge graph formation method of claim 11, wherein the generated knowledge graph includes an individual topic tree and a related subtree of at least one children node closest to a root node of the individual topic tree.

13. The knowledge graph formation method of claim 11, wherein the customer user behavior includes at least one of a computer mouse motion, a copy and paste operation, highlighting text of an article of the search results, bookmarking an article of the search results, or forwarding an article of the search results.

14. The knowledge graph formation method of claim 10, further comprising:
in response to analyzing the computer user behavior regarding the search results, extracting, by the one or more processors of the computer system, the search results from entities and relationships and combining interactive behavior permissions established by recording the topic of interest and search results clustered into the hierarchical knowledge tree format to form the knowledge graph of the specific topic tree and a result from sub-topics branched from the knowledge tree.

15. The knowledge graph formation method of claim 10, further comprising:
generating, by the one or more processors of the computer system, a new version of the knowledge graph by outputting additional information from reprocessed documents of the search results.

16. The knowledge graph formation method of claim 10, further comprising:
adding or modifying, by the one or more processors, data regarding an initial inquiry;
inputting information corresponding to the reprocessed documents for generating the new version of the knowledge graph;
generating, by the one or more processors, an answer based on either the version of the knowledge graph or amount of use of the answer.

17. The knowledge graph formation method of claim 15, further comprising, wherein the new version of the knowledge graph is generated in response to user-entered information as part of adding or modifying, by the one or more processors, data regarding an initial inquiry.

18. The knowledge graph formation method of claim 10, further comprising:
receiving, by the one or more processors, an additional search condition or criteria; and
generating, by the one or more processors, a new or modified knowledge graph.

19. A computer program product for optimizing a knowledge graph formation process, the computer program product comprising:
one or more computer readable storage media having computer readable program code collectively stored on the one or more computer readable storage media, the computer readable program code being executed by a central processing unit (CPU) of a computer system to cause the computer system to perform a method, said method comprising:
clustering data of search results of a topic of interest into a hierarchical format;
monitoring user behavior regarding the search results; and
processing a determined result of the monitored computer user behavior and the clustered data of the search results to generate a knowledge graph based on the topic of interest.

20. The computer program product of claim 19, the method further comprising:
in response to analyzing the computer user behavior regarding the search results, extracting, by the one or more processors, the search results from entities and relationships and combining interactive behavior permissions established by recording the topic of interest and search results clustered into the hierarchical knowledge tree format to form the knowledge graph of the specific topic tree and a result from sub-topics branched from the knowledge tree.
